(19) United States
(12) Patent Application Publication
(10) Pub. No.: US 2025/0033532 A1
(43) Pub. Date: Jan. 30, 2025

(54) Seat Body for a Seat Element of a Motor Vehicle, Seat Element With a Seat Body and a Switch Device and Motor Vehicle With a Seat Element of This Type

(71) Applicant: BAYERISCHE MOTOREN WERKE AKTIENGESELLSCHAFT, Muenchen (DE)

(72) Inventor: Matthias OESTERREICH, Muenchen (DE)

(21) Appl. No.: 18/716,195

(22) PCT Filed: Jan. 11, 2023
(86) PCT No.: PCT/EP2023/050504

§ 371 Date: Jun. 4, 2024

(30) Foreign Application Priority Data
Jan. 21, 2022 (DE) 10 2022 101 399.5

(51) Int. Cl. B60N 2/02; B60N 2/58

(52) U.S. Cl. CPC B60N 2/0231; B60N 2/0228; B60N 2/58

(57) ABSTRACT

A seat body for a seat of a motor vehicle includes a support element having a securing surface and a seat cover surface opposite the securing surface, as well as a connecting body receptacle into which a connecting body of a switch device can be inserted, which is held on the support element in the inserted state in such a way that an actuation element secured to the connecting body ends at the seat cover surface. The seat cover surface of the support element is covered by a seat cover, whereby the connecting body receptacle is covered by the seat cover, such that, if the connecting body is inserted into the connecting body receptacle as intended, the actuation element is covered by the seat cover.

### BACKGROUND AND SUMMARY

The present invention relates to a seat body for a seat element of a motor vehicle, in particular a motor vehicle of the type having a saddle seat system, i.e., for example, for a motorcycle, an ATV (all-terrain vehicle or “quad”), etc. Furthermore, the invention relates to a seat element for a motor vehicle of this type, the seat element having a seat body and a switch device. The switch device can be used to control one vehicle function or a multiplicity of vehicle functions by an actuating element being adjusted by a (human) user of the seat element, for example a driver or passenger of the motor vehicle equipped with the seat element. In addition, the invention relates to a motor vehicle, in particular a motorcycle, with a seat element of this type.

Seat heaters for motor vehicles are known, for example from DE 196 39 750 A1 or from DE 10 2004 034 675 A1. In the motorbike sector, for example, a rider's seat heater can be switched on/switched off, switched over and/or controlled by the rider using an operator control element arranged in the region of the motorbike handlebar, for example a seat heater switch, and/or using a corresponding control command input into a vehicle operator control system, which is based on a selection menu, in the region of an instrument cluster. Such operator control elements are known, for example, from DE 10 2017 212 064 A1 or from DE 10 2016 203 194 A1. There are motorcycle models in which a pillion passenger seat heater does not have their own assigned operator control element; instead, the operator control element of the pillion passenger seat heater is located in the region of the motorbike handlebar, and therefore only the rider has access to it in the riding mode. In this case, the pillion passenger therefore has no option for switching the pillion passenger seat heater without having to distract the rider. This is because the pillion passenger has to make the rider aware of them to then make their desire clear that the seat heater should be operated, so that the rider can then adjust the pillion passenger seat heater. Furthermore, it is known to arrange an operator control element for controlling the pillion passenger seat heater in a region accessible to the pillion passenger. A conventional seat heater operator control element may be, for example, a mechanical rocker switch which, by means of its latching positions, characterizes the switch position and therefore the heating stage.

Conventionally, such seat heater operator control elements are connected to a seat pan of the corresponding seat by means of an operator control element support, with an actuating element of the operator control element jutting out from a cover of the seat and penetrating the latter. As a result, there is a gap between the operator control element and the cover, with there nowadays being an attempt to close or to cover said gap by means of additional panels. Such panels fit esthetically only poorly into an overall appearance of the seat and consequently of the corresponding vehicle. Furthermore, such a construction has a particularly large amount of parts which have to be connected to one another to produce the seat. Furthermore, it may be the case that a liquid, for example rain water, undesirably penetrates or runs through the gap into the interior of the seat and damages the vehicle there. Furthermore, the seat is harder at least at the location of the operator control element or the panel, and therefore it may be the case that a user of the seat is forced into an uncomfortable sitting position to avoid butting with a body part against the panel.

It is the object of the invention to provide a possibility of integrating an operator control element for controlling a vehicle function particularly efficiently into a seat system of the vehicle.

This object is achieved by the subjects of the independent claims. Features, advantages and possible refinements which are presented within the scope of the description for one of the subjects of the independent claims should be considered at least analoguously as features, advantages and possible refinements of the respective subject matter of the other independent claims and of any possible combination of the subjects of the independent claims. Further possible refinements of the invention are disclosed in the dependent claims, the description and the FIGURES.

According to the invention, a seat body for a seat element is proposed. In the position fitted as intended, the seat element has the seat body. The seat element is designed here for use in/at a motor vehicle. Accordingly, the motor vehicle, when it is finished or produced ready for use, has the seat body by the motor vehicle having the seat element. The motor vehicle is in particular a motor vehicle with a saddle seat system, e.g. a motorcycle or motorbike or another (possibly unmotorized) vehicle which has such a saddle seat system. In addition, the seat body or the seat element having the seat body is suitable for use in/at other vehicles, such as cars.

The seat body has a support element which may be referred to—in particular in motorbike engineering—as a seat pan. The support element has a fastening surface and a seat cover surface opposite the fastening surface, wherein the fastening surface and the seat cover surface are spaced apart from each other and face away from each other via a material thickness of the support element. The seat body is connectable to a seat supporting structure of the motor vehicle by means of the support element, that is by means of the seat pan. For this purpose, at least the fastening surface of the support element and the support structure of the motor vehicle are designed to be fixed as intended to each other, for example screwed to each other and/or connected in some other way with a force fit, form fit and/or integral bond.

Furthermore, the seat body has a connecting body receptacle, into which a connecting body of a switch device is insertable. In other words, the connecting body receptacle is designed (that is arranged and configured) to receive the connecting body. The switch element is an operator control element, by means of which a user, for example driver or passenger/pillion passenger, of the motor vehicle/motorbike can control one vehicle function or a multiplicity of vehicle functions. For this purpose, the user actuates an actuating element of the switch device, for example the user deflects the actuating element out of an actuating element position in order to adjust it into another actuating element position. The switch device can be designed, for example, monostably, e.g. as a button. Furthermore, the switch device can be designed bistably, e.g. as a toggle switch. In addition, it is conceivable for the switch device to be designed tristably, e.g. as a toggle switch which is adjustable into three switching positions. The switch device can furthermore have a multiplicity of switches and/or buttons.

The motor vehicle therefore has the switch device which is electrically connected or connectable to an electrical system of the motor vehicle. Consequently, the connecting body can have an electrical coupling element, e.g. a socket or a plug, which is coupleable to a corresponding electrical coupling element of the electrical system, that is a plug or a socket, in order to produce an electrically conducting or conductive connection. It is conceivable for the electrical coupling element to be integrated in the connecting body; for example, the connecting body and a coupling element housing may be formed integrally with each other. The coupling element housing can be at least partially formed by the connecting body, or vice versa.

The connecting body receptacle is configured in such a manner that, in the state inserted into the connecting body receptacle, the connecting body is held at the support element in such a manner that the actuating element, which is fastened to the connecting body, ends at the seat cover surface. The connecting body receptacle is, for example, a shaft which corresponds in respect of geometry and size to the connecting body and into which the connecting body is insertable or, in the case of the seat element, is inserted. An actuating surface of the actuating element and the seat cover surface of the support element act in the same direction, that is they face in the same direction. For example, a surface profile or a surface configuration of the seat cover surface of the support element is continued by the actuating element, in particular the actuating surface thereof.

The seat cover surface of the seat body is covered, in particular spanned, by a seat cover element, as a result of which the connecting body receptacle is covered by the seat cover element such that—when the connecting body is inserted as intended into the connecting body receptacle—the actuating element is covered by the seat cover element. In particular, a padding material can be arranged between the seat cover surface and the seat cover element in order to provide padding characteristics of the seat body or of the seat element equipped therewith. The single- or multi-part and/or single- or multi-layered seat cover element in particular involves leather or a leather-like material or another seat cover material.

Since the seat body is covered with the seat cover element, with the connecting body receptacle being covered, there is no gap on the outside of the seat body and, in consequence, on the outside of the seat element. The seat cover element is placed or tensioned continuously over the seat body (and over the possibly present padding material), thus resulting in a closed outer surface of the seat body or seat element. The connecting element receptacle therefore fits particularly esthetically into the overall appearance of the seat body. Furthermore, the gap-free outer surface ensures that no liquid, e.g. rain water, penetrates into the interior of the seat body. It is therefore possible to dispense with the production of a panel (as in the case of conventional operator control elements), which results in an advantageously particularly simple structure of the seat body and in a particularly efficient design of the seat body in terms of mass production, since it has few components. Furthermore, some process steps can be omitted during the production of the seat body, e.g. fastening of an operator control element to the panel, handling and aligning the panel at a conventional support element, fastening the panel to this support element, etc. Furthermore, corresponding connecting means, such as adhesive agents, screwing elements and the like, are omitted, and therefore the seat body, the seat element and the correspondingly equipped motor vehicle, in particular motorcycle, can be produced particularly advantageously ecologically.

In a further possible embodiment of the seat body, a support element material body of the support element and the connecting body receptacle are formed integrally with each other. The support element can thus generally be a cast part, in particular injection molded part—e.g. made from plastic and/or a metallic material. In the production of the support element, during the primary forming of the support element, the support element material body and the connecting body receptacle are then formed, e.g., simultaneously or in a common working step, by means of the primary forming of the support element. It is thus advantageously provided that connecting means (screwing elements, adhesive agents, etc.) for connecting the connecting body receptacle to the support element material body are omitted, which again promotes a particularly lightweight construction of the seat body. The support element material body and the connecting body receptacle are fastened here particularly securely to each other such that the seat body is particularly stable.

According to a further possible refinement of the seat body, the connecting body receptacle has, on the fastening surface, a mounting opening through which the connecting body is insertable into the connecting body receptacle. This means that before the switch device, in particular the connecting body thereof, is mounted in the connecting body receptacle, the support element can already be covered/spanned by the seat cover element. In other words: for the insertion of the connecting body into the connecting body receptacle, the seat cover element does not have to be separated in a complicated way from the support element. The seat body can thus be produced particularly simply. Furthermore, removal of the switch device is configured particularly simply in a desirable manner since the switch device can be removed from the connecting body receptacle through the mounting opening, with removal and subsequent recovering of the seat cover element advantageously not taking place. By this means, the seat body and, as a result, the seat element or motor vehicle having the seat body can be repaired or can be maintained particularly simply since an exchange of the switch device in the event of a defect thereof is particularly easy.

In a development of the seat body, the support element, in particular the connecting body receptacle thereof, has a fixing device which is designed—when the connecting body is inserted as intended into the connecting body receptacle—to fix the connecting body in and/or at the connecting body receptacle with a force fit, form fit and/or integral bond. As a result, the connecting body sits particularly securely in the connecting body receptacle, which contributes in particular to avoiding annoying noises and consequently to a particularly advantageous NVH quality (NVH: noise, vibrations, harshness). The fixing device has a first latching element or a plurality of first latching elements, e.g. on the connecting body receptacle, the switch device having a second latching element or a plurality of second latching elements, e.g. on the connecting body. The respective first latching element and the respective second latching element correspond to each other here. The latching elements are configured here to form a latching device which is reversibly releasable without being destroyed. In order to mount/remove the switch device, one of the latching elements or a plurality of the latching elements of the latching device is or are reversibly elastically adjustable, for example stretchable, from a latching position into a release position without being destroyed. Alternatively or additionally, the fixing device can have a screw connection element or a plurality of screw connection elements, wherein the respective screw connection element is configured to form a screw connection which is reversibly releasable without being destroyed with a correspondingly associated/assigned screw connection element formed on the connecting body.

A development of the seat body makes provision for a padding material to be arranged on the seat cover surface—i.e. between the seat cover element and the seat cover surface. The connecting element receptacle here is free from the padding material. The connecting element receptacle is therefore not covered by the padding material or extends completely through the padding material. The seat cover element is then arranged at least partially on a padding element surface of the padding material facing away from the seat cover surface, wherein a depth of the connecting body receptacle is designed in such a manner that the connecting body—when the latter is inserted as intended into the connecting body receptacle, that is, in the case of the seat element—is held positionally in such a manner that the actuating element ends at the padding element surface. The actuating surface of the actuating element and the padding element surface act in the same direction, that is, they face in the same direction. For example, a surface profile or a surface configuration of the padding element surface of the padding material is continued by the actuating element, in particular the actuating surface thereof. For the seat element, in which the switch device is inserted by the connecting body being inserted as intended into the connecting body receptacle, it therefore applies that the actuating element can advantageously be reached and actuated particularly easily by the user. This is because the actuating element is not covered by the padding material, and therefore the user does not have to press through the padding material in order to move the actuating element.

In yet another embodiment of the seat body, the seat cover element comprises a marking arrangement which corresponds positionally with the connecting body receptacle. The marking arrangement is formed or arranged in particular at/on the outer surface of the seat cover element and is connected to the outer surface with a force fit, form fit and/or integral bond, e.g. is sewn, adhesively bonded, welded, screwed, riveted, etc. Alternatively or additionally, it is conceivable for the outer surface of the seat cover element to be at least partially formed by the marking arrangement. Accordingly, the marking arrangement can be an integral part of the seat cover element. The marking arrangement has one or more of the following marking elements:
a color marking,
an impression,
an embroidered structure,
a stitched structure,
a marking cover element,
a badge.

Since the marking arrangement and the connecting body receptacle correspond positionally with each other, that is, with respect to their respective position, it is particularly easy for the user to find the switch device and to switch or to control the corresponding vehicle function(s). For this purpose, a symbol characterizing the corresponding vehicle function(s), e.g. a symbol for a heating function, in particular seat heater function, etc., can be provided by the at least one marking element.

The invention also relates to a seat element which has a seat body and a switch device, which are designed according to the above description.

In a development of the seat element, in particular of the switch device, the actuating element of the switch device has a haptic body which extends in the direction of the seat cover element and stands out tangibly on an outer surface of the seat cover. In this way, a position of the actuating element can be felt by a user, and therefore the user particularly efficiently finds the position or installed position of the switch device and, as a result, of the actuating element.

In the case of the seat element, provision is made, according to a further embodiment, for the actuating element of the switch device to have a position control body which extends in the direction of the seat cover element and stands out tangibly on an outer surface of the seat cover in one of the actuating element positions, into which the actuating element is adjustable. The user can thus feel particularly easily in which of the switching positions the switch device or the actuating element thereof is arranged. This advantageously obviates the need for looking around, as a result of which the user, in particular if they are the driver of the motor vehicle or rider of the motorbike, can keep looking at the traffic. To this extent, the seat element contributes to road safety.

Furthermore, the invention relates to a motor vehicle, in particular motorcycle, which is equipped with a seat element designed according to the above description.

Further features of the invention can emerge from the claims, the FIGURE and the description of the FIGURE. The features and combinations of features mentioned above in the description and the features and combinations of features shown below in the description of the FIGURE and/or in the FIGURE alone are usable not only in the respectively stated combination, but also in different combinations or by themselves without departing from the scope of the invention.

### BRIEF DESCRIPTION OF THE DRAWING

FIG. 1 is a schematic and sectioned view of a seat element designed for a motor vehicle, in particular a motorcycle, having a seat body and a switch device.

In the FIGURE, identical and functionally identical elements are provided with the same reference signs.

### DETAILED DESCRIPTION OF THE DRAWING

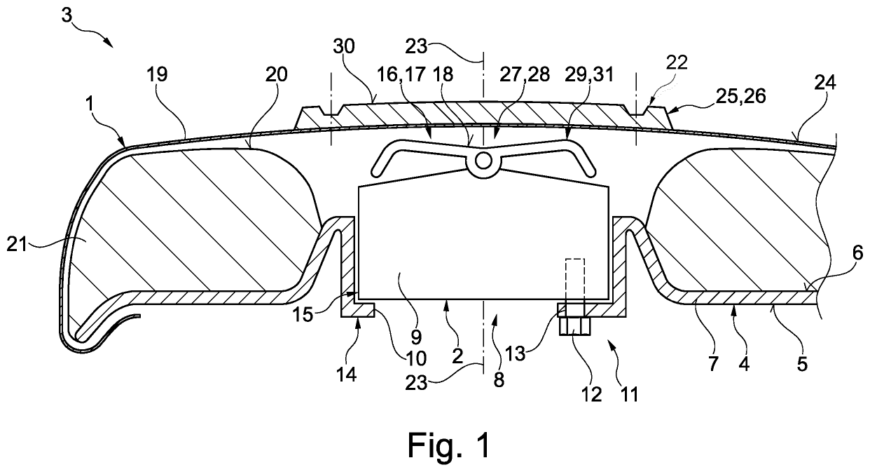

Referring to FIG. 1 and the following, a seat body 1, a seat element 3 having the seat body 1 and a switch device 2, and a motor vehicle (not illustrated overall) designed in the present example as a motorcycle or motorbike are presented in a joint description. In a position installed as intended, a seat system, in particular a saddle seat system, of the motor vehicle or motorbike or motorcycle is formed by the seat element 3. This means that the motorbike has the seat element 3 and, as a result, the seat body 1 as part of the seat system. The seat element 3 is, for example, a seat cushion or a backrest. Furthermore, the seat element 3 can be a saddle seat element on which a user of the corresponding seat system sits astride.

It can be seen in FIG. 1 that the seat body 1 has a support element 4, which here is a seat pan. In the case of the motorbike, that is, in the position of the seat element 3 installed as intended, a fastening surface 5 of the support element 4 faces a frame or a support structure of the motorcycle. The seat element 3 is fastened or fixed here to the support structure or to the frame of the motorbike by means of the support element 4, in particular by means of the fastening surface 5 thereof. The support element 4 furthermore has a seat cover surface 6 opposite the fastening surface 5. The surfaces 5, 6 are spaced apart from each other here via a material thickness of a support material body 7 of the support element 4.

The seat body 1 furthermore has a connecting body receptacle 8, wherein the support material body 7 and the connecting body receptacle 8 are formed integrally with each other. Therefore, both the support material body 7 and the connecting body receptacle 8 form a respective integral part of the support element 4. The connecting body receptacle 8 here is a shaft, into which a connecting body 9 of the switch device 2 is insertable or—as illustrated here in FIG. 1—is inserted. For this purpose, the connecting body receptacle 8 has, on the fastening surface 5, a mounting opening 10 through which the connecting body 9 has been inserted into the connecting body receptacle 8.

If the switch device 2 or the connecting body 9 thereof has been inserted as intended into the connecting body receptacle 8, the switch device 2 is positionally fixed with a force fit, form fit and/or integral bond by means of the connecting body 9 in the connecting body receptacle 8—and in particular by means of the connecting body receptacle 8—that is, is held in respect of a position in the connecting body receptacle 8. For this purpose, it is provided that the connecting body receptacle 8 and the connecting body 9 are formed corresponding with each other in respect of geometry and size.

In order to ensure a particularly secure fit of the switch device 2 or of the connecting body 9 in/at the connecting body receptacle 8, the support element 4 here has a fixing device 11 which can be formed, for example, at/in the connecting body receptacle 8. A screw connecting element 12, here a screw bolt, is illustrated merely by way of example in FIG. 1 and runs through a screw hole 13 in the support element 4 or in the connecting body receptacle 8 and engages in the connecting body 9, wherein a threaded connection is provided between the screw bolt and the connecting body 9. Furthermore, it can be seen in FIG. 1 that, in the present example, the fixing device 11 has a latching element 14 on the support-element side which, in its relaxed position, interacts with a latching element 15 on the connecting-element side (which latching element can be formed, for example, by an edge of the connecting body 9), such that a latching connection is provided between the support element 4 and the connecting body 9 by means of the fixing device 11.

The switch device 2 furthermore has an actuating element 16 which is designed here as a rocker switch 17 or has such a rocker switch 17. By an adjustment, for example, toggle switching, of the rocker switch 17, a vehicle function, in particular a seat heater, of the motorbike is activated or deactivated or adjusted. It can be seen that the actuating element 16 ends at the seat cover surface 6, or the surface profile and/or surface configuration thereof is continued by an actuating surface 18 of the actuating element 16.

The seat body 1 furthermore has a seat cover element 19 with which the seat cover surface 6 of the support element 4 is covered here by a padding element surface 20 of a padding material 21 being covered or spanned by the seat cover element 19. This means that the padding material 21, for example a foam structure, is arranged and in particular fastened between the seat cover surface 6 and the seat cover element 19. The connecting body receptacle 8 is free here from the padding material 21, that is to say is not overlapped by the padding material 21 in the direction of the seat cover element 19.

The connecting body receptacle 8 is covered by the seat cover element 19 such that—when the connecting body 9, as illustrated here in FIG. 1, is inserted as intended into the connecting body receptacle 8—the actuating element 16 is covered or overlapped or spanned by the seat cover element 19. In simplified terms, the switch device 2 is arranged below the seat cover element 19.

A depth of the connecting body receptacle 8 is designed in such a manner that the connecting body 9 is held or fixed by means of the connecting body receptacle 8 in such a manner that the actuating element 16 ends at the cushion element surface 20.

FIG. 1 furthermore illustrates a marking arrangement 22 which corresponds positionally with the connecting body receptacle 8. This means here that the marking arrangement 22 and the connecting body receptacle 8 have a common longitudinal central axis 23. A local position of the connecting body receptacle 8 and, as a result, of the switch device 2 held by means of the connecting body receptacle 8 is therefore marked or indicated at/on an outer surface 24 of the seat cover element 19 by the marking arrangement 22. This is because the marking arrangement 22 is arranged at/on the outer surface 24 or at least partially forms the latter. The marking arrangement 22 has here one or more of the following marking elements 25: a color marking, an impression, an embroidered structure, a stitched structure, a marking cover element (which differs optically and/or haptically from the seat cover element), etc. In the present case, the marking arrangement 22 has a flexible or flexurally slack or rigid badge 26 which is connected to the seat cover element 19 with a force fit, form fit and/or integral bond. For example, it can be provided that the badge 26 is welded, riveted, sewn, adhesively bonded, etc., onto the outer surface 24 of the seat cover element 19.

FIG. 1 furthermore shows that the actuating element 16 of the switch device 2 has a haptic body 27 which extends in the direction of the seat cover element 19 and stands out tangibly on the outer surface 24 of the seat cover element 19. The haptic body 27 is of such a size and hardness that it can be felt by a user of the seat body through the seat cover element 19 and possibly also through the marking arrangement 22. The haptic body 27 is formed here by the actuating element 16, that is, by the rocker switch 17 here. For example, a shaped structure 28 (e.g. a depression) of the rocker switch 17 thus serves as the haptic body 27 which can be felt by the user. It is just as readily conceivable for a haptic body 27 which is formed separately from the actuating element 16 and is connected to the actuating element 16 to be provided.

In addition, the actuating element 16 or the rocker switch 17 of the switch device 2 has a position control body 29 which extends in the direction of the seat cover element 19 and stands out tangibly on an outer surface 24 of the seat cover element 19 in at least one of the actuating element positions, into which the actuating element 16 is adjustable. If the marking arrangement 22 is provided on the outer surface 24 at the location of the actuating element 16, the position control body 29 stands out on an outer surface 30 of the marking arrangement 22. This applies analoguously for the standing-out of the haptic body 27 on the corresponding outer surface 24, 30. The position control body 29 is formed here by an edge 31 of the actuating element 16. It is just as readily conceivable for a position control body 29 which is formed separately from the actuating element 16 and is connected to the actuating element 16 to be provided. In particular, it is provided that a number of position control bodies 29 corresponds to a number of possible actuating element positions. A respective actuating element position or switching position is characterized here by a respective one of the position control bodies 29. By this means, the user, by feeling the corresponding position control body 29, can find out into which actuating element position the actuating element 16 is currently adjusted.

In order to feel the haptic body 27 and/or in order to feel the position control body 29 or the position control bodies 29, it can be provided that the user presses or indents the seat cover element 19 with one of their fingertips in order to produce noticeable/tangible mechanical contact between the fingertip and the corresponding one of the bodies 27, 29. The seat cover element 19 and/or optionally the marking arrangement 22 here are/is reversibly elastically tensioned as intended.

Overall, a respective possibility is provided by the seat body 1, by the seat element 3 and by the motor vehicle or motorbike for integrating an operator control element (here the switch device 2) for controlling a vehicle function (for example a seat heater control) particularly efficiently into a seat system of the vehicle, in particular of the motorbike or the car. The longitudinal central axis 23 can be arranged here parallel to a forward direction of travel, a transverse direction or a vertical direction of the motor vehicle. To this extent, the actuating element 16 can face upward, to the right, to the left or downward. It should furthermore be understood that the motor vehicle can have at least one further seat body 1 or at least one further seat element 3. The respective seat element 3 can have here at least one further switch device 2. This means that the respective seat body 1 has a correspondingly large number of connecting body receptacles 8.

A conventional transition between a conventional switch device and the seat cover element is avoided as desired by the invention. In particular, an extra panel made from plastic or a switch console made from plastic—in each case generally in the form of a complicated, black and grained injection molded component—is dispensed with. A complicated precisely fitting orientation of such a plastics component is advantageously omitted. Component edges protruding over the seat cover element 19, and holes and gaps between the panel and the seat cover element 19 are likewise avoided, as is (e.g. aging-induced) distortion/deformation of the panel.

By means of the now continuous seat cover element 19, the operator control functionality for operating the at least one vehicle function by means of the switch device 2 fits particularly attractively into the overall appearance of the motorbike seat bench.

A toggle switch or push button is accommodated/recessed in the seat pan or in the support element 4 to such an extent/such a depth that it can be upholstered together with the seat cover element 19, optionally with the badge, and that it still remains noticeable, perceivable and operable for the user. The badge is welded onto the seat cover element 19 or is stitched to the seat cover element 19 and receives a graphical enhancement emphasizing the operator control element of the seat heater, namely the switch device 2 concealed by the seat cover element, and optionally the switching position or actuating element position. For particularly ergonomic operation and for a particularly long service life of the seat body 1 or the seat element 3, the actuating element can be designed with rounded edges 31.

### LIST OF REFERENCE SIGNS

1 seat body
2 switch device
3 seat element
4 support element
5 fastening surface
6 seat cover surface
7 support material body
8 connecting body receptacle
9 connecting body
10 mounting opening
11 fixing device
12 screw connecting element
13 screw hole
14 latching element
15 latching element
16 actuating element
17 rocker switch
18 actuating surface
19 seat cover
20 padding element surface
21 padding material
22 marking arrangement
23 longitudinal central axis
24 outer surface
25 marking element
26 badge
27 haptic body
28 shaped structure
29 position control body
30 outer surface
31 edge

1.-10. (canceled)

11. A seat body of a motor vehicle, comprising:
a support element having a fastening surface and a seat cover surface opposite the fastening surface;
a connecting body receptacle, into which a connecting body of a switch device is insertable into the connecting body receptacle, wherein, in an inserted state, the connecting body is held on the support element such that an actuating element fastened to the connecting body ends at the seat cover surface; and, wherein
a seat cover that covers the seat cover surface of the support element, as a result of which the connecting body receptacle is covered by the seat cover such that, when the connecting body is inserted as intended into the connecting body receptacle, the actuating element is covered by the seat cover.

12. The seat body according to claim 11, wherein
a support element material body of the support element and the connecting body receptacle are formed integrally with each other.

13. The seat body according to claim 11, wherein
the connecting body receptacle has, on the fastening surface, a mounting opening through which the connecting body is insertable into the connecting body receptacle.

14. The seat body according to claim 11, wherein
the support element has a fixing device which is designed, when the connecting body is inserted as intended into the connecting body receptacle, to fix the connecting body in and/or at the connecting body receptacle.

15. The seat body according to claim 11, further comprising:
a padding material arranged on the seat cover surface, wherein
the connecting body receptacle is free from the padding material,
the seat cover is arranged on a padding element surface facing away from the seat cover surface,
a depth of the connecting body receptacle is designed such that the connecting body, when inserted as intended into the connecting body receptacle, is held such that the actuating element ends at the padding element surface.

16. The seat body according to claim 11, wherein
the seat cover comprises a marking arrangement which corresponds positionally with the connecting body receptacle and has one or more of the following marking elements:
a color marking,
an impression,
an embroidered structure,
a stitched structure,
a marking cover element, or
a badge.

17. A seat, comprising:
a seat body according to claim 11; and
the switch device having the connecting body.

18. The seat element according to claim 17, wherein
the actuating element of the switch device has a haptic body which extends in the direction of the seat cover and stands out tangibly on an outer surface of the seat cover.

19. The seat element according to claim 17, wherein
the actuating element of the switch device has a position control body which extends in the direction of the seat cover and stands out tangibly on an outer surface of the seat cover element in an actuating element position into which the actuating element is adjustable.

20. A motor vehicle comprising a seat according to claim 17.
